(19) United States
(12) Patent Application Publication
(10) Pub. No.: US 2006/0044786 A1
(43) Pub. Date: Mar. 2, 2006

(54) Illuminating base

(76) Inventor: Dennis Johnson, Prior Lake, MN (US)

Correspondence Address: Roger L. Belfay, 829 Tuscarora Avenue, Saint Paul, MN, 55102, US

(21) Appl. No.: 10/925,397

(22) Filed: Aug. 25, 2004

(51) Int. Cl. F21V 33/00

(52) U.S. Cl. 362/101; 362/154

(57) ABSTRACT

The base for illuminating the interior of one or more containers is a base for use with and for illuminating transparent or translucent containers, the containers having a side wall and a bottom end portion comprised of a bottom wall at least a portion of which is at least partly transparent to light, the base comprising: a main body comprised of, an upwardly-disposed side wall provided with a reflective surface to increase the diffusion of light within the base to provide more uniform illumination of the containers.

### BACKGROUND OF INVENTION

The beauty and attractiveness of translucent and transparent containers is enhanced when they appear to be lit from the inside. A number of devices have been devised to accomplish this objective.

One class of such devices is those which attempt to provide illumination of images or designs present on or embedded in the illuminated object. This class is exemplified by U.S. Pat. No. 5,662,406 to Mattice, U.S. Pat. No. 5,785,407 to Ratcliffe, and U.S. Pat. No. 6,213,616 B1 to Tseng-Lu.

Another class of such devices includes those in which the light providing mechanism is at least in part inherent to the object being illuminated. U.S. Pat. No. 6,062,380 to Domey, U.S. Pat. No. 6,086,216 to Goldfarb, U.S. Pat. No. 6,254,247 to Carson, U.S. Pat. No. 6,352,352 to Schletterer are exemplary of this class of devices. U.S. Pat. No. 6,520,657 B1 to DeNicola is also a member of this class because the light producing mechanism is triggered by attachment to the base of the illuminated vessel through a clip-on action permitted by a circumferential groove provided in the illuminated vessel for this purpose.

A third class of devices addressing this problem are those which require a translucent or transparent object which is interposed between the light source and the illuminated object to support said object. Exemplars in this class include U.S. Pat. No. 4,325,110 to Woei, U.S. Pat. No. 4,336,574 to Goodman, U.S. Pat. No. 5,307,250 to Pearson, U.S. Pat. No. 6,082,866 to Amedee, and U.S. Pat. No. 6,286,719 B1 to Haines.

Yet another class of devices uses fiber optics to convey the light from the light source to the object. Exemplars of this approach are U.S. Pat. No. 5,915,832 to Baird and 6,379,018 B1 to Rycroft.

U.S. Pat. No. 6,065,848 to Tucker et al. and all of the above mentioned devices, except for those using fiber optics, use whatever light the light source provides without attempting to moderate the uneven intensity provided to the illuminated surface. The class of devices using fiber optic techniques provides light of whatever intensity is is available where the fiber optic carriers terminate and dispense their light. It is an object of the present invention to overcome the inherent difficulties found in the existing devices above and to provide a chamber for one or more light sources in which a more uniform light intensity reaches the illuminated surface of the illuminated object to provide a more uniform and esthetically pleasing illumination pattern.

### BRIEF SUMMARY OF THE INVENTION

The illuminating base is a base for use with and for illuminating a plurality of containers for liquids, the plurality of containers having a side wall and a bottom end portion comprised of a bottom wall at least a portion of which is at least partly transparent to light, the base comprising: a main body comprised of, an upwardly-disposed side wall provided with a reflective surface to increase the diffusion of light within the base to provide more uniform illumination of the plurality of containers, a plurality of mounts for mounting a plurality of light sources such that at least some light from the light sources is directed toward the bottom wall of the plurality of containers when the containers are supported on the base, a support structure to support the container thereon, whereby the base is adapted to illuminate the interior of the containers through their bottom wall, and a bottom wall.

### BRIEF DESCRIPTION OF THE DRAWINGS

FIG. 1 is a perspective view of the invention, in use.

FIG. 2 is a sectional view of the illuminating base of FIG. 1.

FIG. 3 is a perspective view of a dual base embodiment.

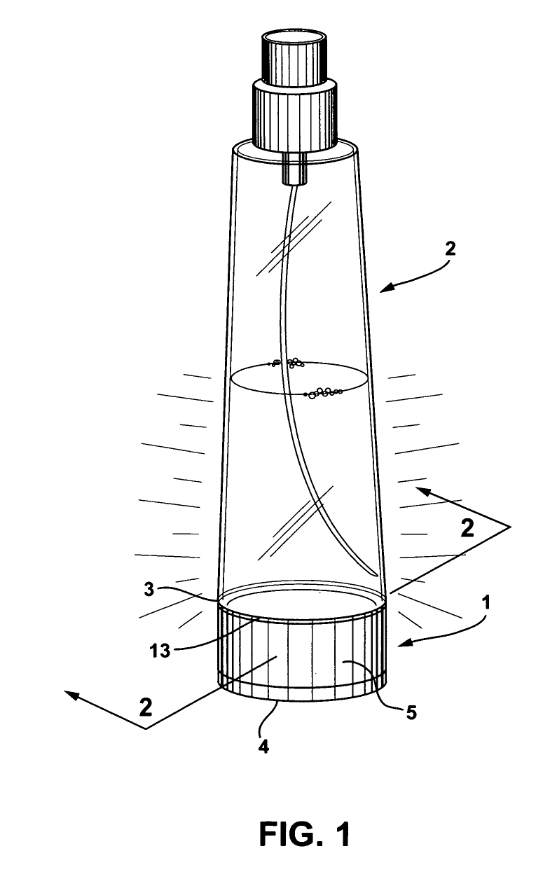

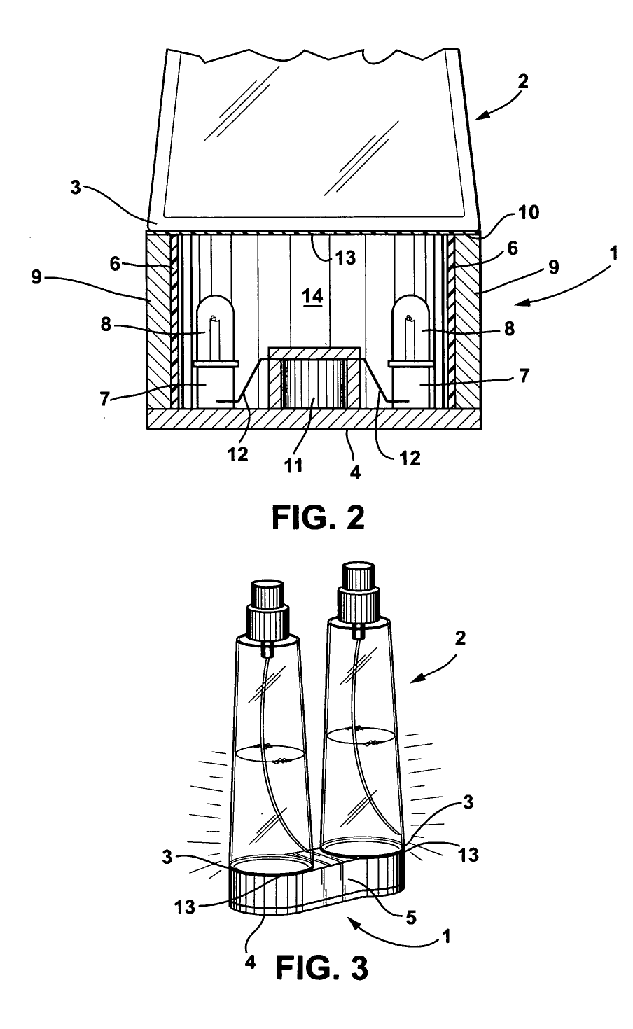

### DETAILED DESCRIPTION

The illuminating base 1 is a base 1 for use with and for illuminating a plurality of containers 2 for liquids, the plurality of containers 2 having a side wall and a bottom end portion 3, at least a portion of which is at least partly transparent to light, said base 1 comprising: a main body 5 comprised of, an upwardly-disposed side wall provided with a reflective surface 6 to increase the diffusion and reflection of light within the base 1 to provide more uniform illumination of the plurality of containers 2, a plurality of mounts 7 for mounting a plurality of light sources 8 such that at least some light from the light sources 8 is directed toward the bottom end portion 3 of the plurality of containers 2 when the containers 2 are supported on the base 1, a support structure 9 to support the container thereon, whereby the base 1 is adapted to illuminate the interior of the containers 2 through their bottom end portion 3, and a bottom wall 4. Said bottom wall 4 may be adapted to receive and hold at least one battery 11. The base 1 may further comprise conductors 12 in communication with the light sources 8 and at least one battery 11 to complete an electrical circuit there among to energize the light sources 8. The plurality of light sources 8 may be chemically luminescent light sources 8. The base 1 may further comprise a cover shield 13 to assure that the light from the light sources 8 does not fall directly on the bottom end portion 3 of the containers 2 but is reflected or refracted by the reflective surface 6 of the chamber 14 containing the light sources 8 within the base 1. This cover shield 13 may be a single shield 13 or it may be a set of shields 13 designed to make the light reaching the bottom end portion 3 of the container 2 more uniform.

The reflective surface 6 is composed of any material suitable for lining the interior of the base 1 such as paper, cardboard, paint, or a polishing of the interior surface of the base 1. The reflective surface 6 may marked with a name or other suitable indications and may be of a color chosen for esthetic purposes.

It will be appreciated that the support structure provided may consist of any transparent or translucent object designed to make a supportive and esthetically pleasing interface between the base 1 and the container 2. It will also be appreciated that this same function may be accomplished by the judicious preparation of the top 10 of the base 1, obviating the need for such a transition device.

I claim:

1) A base for use with and for illuminating a plurality of containers for liquids, the plurality of containers having a side wall and a bottom end portion comprised of a bottom wall at least a portion of which is at least partly transparent to light, the base comprising;
a) a main body comprised of,
b) an upwardly-disposed side wall provided with a reflective surface to increase the diffusion of light within the base to provide more uniform illumination of the plurality of containers,
c) a plurality of mounts for mounting a plurality of light sources such that at least some light from the light sources is directed toward the bottom wall of the plurality of containers when the containers are supported on the base,
d) a support structure to support the container thereon, whereby the base is adapted to illuminate the interior of the containers through their bottom end portions,
e) a bottom wall.

2) The base of claim 1 with the bottom wall adapted to receive and hold at least one battery.

3) The base of claim 2 further comprising conductors in communication with the light sources and at least one battery to complete an electrical circuit there among to energize the light sources.

4) The base of claim 1 wherein the plurality of light sources are chemically is a plurality of chemically luminescent light sources.

5) The base of claim 1 further comprising a plurality of shields preventing light from the plurality of light sources from directly illuminating the bottom end portions of the plurality of containers.

6) A base for use with and for illuminating a plurality of containers for liquids, the plurality of containers having a side wall and a bottom end portion comprised of a bottom wall at least a portion of which is at least partly transparent to light, the base comprising;
a) a main body comprised of,
b) an upwardly-disposed side wall provided with a reflective surface to increase the diffusion of light within the base to provide more uniform illumination of the plurality of containers,
c) a plurality of mounts for mounting a plurality of light sources such that none of the light from the light sources is directed toward the bottom wall of the plurality of containers when the containers are supported by the base, except indirectly by reflection or refraction by the inner surfaces of the base,
d) a support structure to support the container thereon, whereby the base is adapted to illuminate the interior of the containers through their bottom end portions,
e) a bottom wall.

7) The base of claim 6 with the bottom wall adapted to receive and hold at least one battery.

8) The base of claim 7 further comprising conductors in communication with the light sources and at least one battery to complete an electrical circuit there among to energize the light sources.

9) The base of claim 5 wherein the plurality of light sources is a plurality chemically luminescent light sources.

10) The base of claim 5 further comprising a plurality of shields preventing light from the plurality of light sources from directly illuminating the bottom wall of the plurality of containers.

11) The base of claim 1 wherein the reflective surface reflects a selected spectrum.
